(19) United States
(12) Patent Application Publication
(10) Pub. No.: US 2006/0174496 A1
(43) Pub. Date: Aug. 10, 2006

(54) Rotary tool

(76) Inventor: Michael Skrypnychuk, Calgary (CA)

Correspondence Address: DIEDERIKS & WHITELAW, PLC, 12471 Dillingham Square, #301, Woodbridge, VA, 22192, US

(21) Appl. No.: 11/329,247

(22) Filed: Jan. 11, 2006

(30) Foreign Application Priority Data
Jan. 11, 2005 (CA) 2,492,247

(51) Int. Cl. B26B 9/00

(52) U.S. Cl. 30/347

(57) ABSTRACT

A rotary tool for weed control having a shaft adapted to penetrate the earth at a tip end and adapted to be rotatably driven by a rotary drive at a drive end, and a blade extending from and rotatable with the shaft near the tip end. The rotary tool is inserted into the centre of a weed and rotated by the rotary drive causing the rotary tool to augur into the weed and downward to its roots. Continued rotation of the rotary tool causes the blade to chop and grind the root.

### FIELD OF THE INVENTION

The present invention relates generally to vegetation control. More particularly, the present invention relates to a rotary tool for removing weeds.

### BACKGROUND OF THE INVENTION

Weeds such as dandelions are an ongoing nuisance and require a great deal of time, money and energy to combat.

Manual removal of weeds is a common practise, but requires a lot of uncomfortable bending and kneeling and work by hand. Thus, the use of chemicals such as herbicides to control weeds has been the favoured practise. However, these chemicals may be unhealthy for humans, animals, and the environment.

It is, therefore, desirable to provide a tool useable with a drive that reduces the amount of bending, kneeling, and manual labour associated with known tools for weed control.

### SUMMARY OF THE INVENTION

It is an object of the present invention to obviate or mitigate at least one disadvantage of previous weed control tools.

In a first aspect, the present invention provides a rotatable tool for removing weeds from earth, for use with a rotary drive having an elongate substantially straight shaft comprising a tip end and a drive end, said drive end being adapted to be driven by the drive, said tip end being adapted to penetrate the earth, and a blade extending radially from the shaft, proximate the tip end, connected to and rotatable with the shaft.

Preferably, the blade has substantially planar surfaces, fixed at a blade pitch generally perpendicular to the longitudinal axis of the shaft. More preferably the blade pitch is approximately 20 degrees. Preferably the blade is substantially square. More preferably, the blade has an outer edge tapered inward from a leading edge to a trailing edge, at an edge angle. Preferably the edge angle is approximately 20 degrees. Preferably the blade is a thin knife.

The tip end is generally tapered. Preferably the tip end is substantially conical having a cone angle. Preferably the cone angle is about 7 degrees. Preferably the tip end is radiused at a tip radius. Preferably the tip radius is approximately 1/32″.

Preferably the drive end comprises connection means, adapted to be gripped by the rotary drive. Preferably the connection means comprises a plurality of substantially flat surfaces in the shaft at the drive end, wherein the flat surfaces are adapted to be gripped by the chuck of a rotary drive. Preferably, there are 3 flat surfaces, each at 120 degrees relative to the adjacent one.

Preferably the shaft measures approximately 28.5″ between the tip end and the drive end. Preferably there is approximately 2″ between the tip end and the blade. Preferably the tip portion is approximately 3″ long. Preferably the drive portion is approximately 1.5″ long. Preferably the shaft is approximately ⅜″ in diameter, and is metal.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a side view of a rotary tool in accordance with the invention;

FIG. 2 is a top view of the rotary tool;

FIG. 3 is an end view of the rotary tool; and

FIG. 4 is a view of a blade for the rotary tool.

### DETAILED DESCRIPTION

Generally, the present invention provides a rotary tool for removing or controlling vegetation, e.g. weeds, such as, but not limited to dandelions.

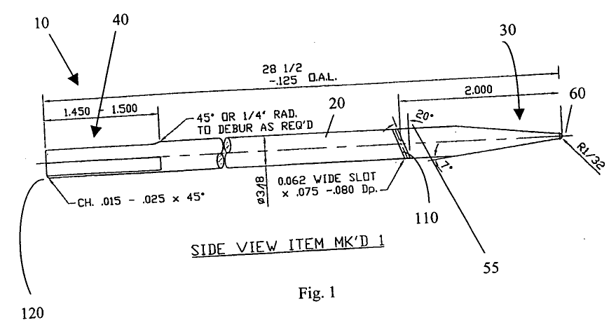

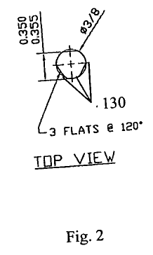

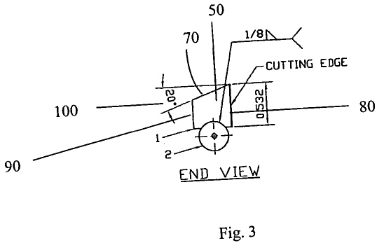

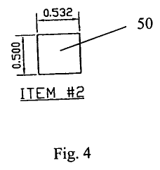

Referring generally to FIGS. 1-4, the rotary tool 10 comprises a shaft 20 having a tip portion 30 and a drive portion 40, and a blade 50 attached to the shaft 20.

A tip 60 in the tip portion 30 is adapted to help the rotary tool 10 penetrate earth (not shown). In the preferred embodiment, the tip 60 is substantially conical. Preferably the tip 60 has a cone angle 65 of approximately 7 degrees. Preferably the tip portion 30 is approximately 2″ long. Preferably the tip 60 is radiused, more preferably radiused 1/32″.

The blade 50 is connected radially to, and rotatable with, the shaft 20. The blade 50 is preferably set at a blade pitch 55 of approximately 20 degrees to provide an auger or drilling effect when rotated. Blade pitch refers to the angle that the blade's planar surfaces bear to a perpendicular to the shaft's longitudinal access. The blade 50 may be thought of as having been rotated 20 degrees along the blade's axis which is radial to the shaft's axis of rotation, to provide a pitch. That pitch provides for an auger or drill effect when the shaft 20 is rotated in one direction, and an extracting force and a grinding or pulverizing effect within the bored hole when later rotated in the other direction. All of these effects are desirable in a tool like this one. The blade 50 is preferably generally square. Preferably the blade 50 has an outer edge 70 tapered inward from a leading edge 80 to a trailing edge 90 at an edge angle 100 of about 20 degrees. This provides for less binding during auguring and better pulverizing during spinning.

In the preferred embodiment, the blade 50 is mounted in a slot 110 formed in the shaft 20; the slot 110 is approximately 0.062″ wide by 0.075″ to 0.080″ deep, and situated approximately 2″ from the tip 60; the blade 50 is constructed of approximately 1/16″ blue temper spring steel; the blade 50 is welded to the shaft 20.

A drive end 120 in the drive portion 40 is adapted to be rotatably driven by a rotary drive (not shown). The rotary drive may be, for example, an electric or battery powered hand tool such as a drill or any other known rotary drive tool (not shown). Preferably, the drive end 120 is received in, and gripped by a chuck (not shown) of the drive. The drive end 120 preferably comprises a plurality of substantially flat surfaces in the form of flats 130 to facilitate retention and gripping by the chuck (not shown). In the preferred embodiment, the drive end 120 comprises three flats 130 each set at 120 degrees to each adjacent one. The drive portion 40 is preferably approximately 1.5″ long.

In the preferred embodiment, the shaft 20 measures approximately 28.5″ long between the tip end 60 and the drive end 120, and the shaft 20 is constructed of steel rod approximately ⅜″ in diameter.

In operation, the drive end 120 of the rotary tool 10 is inserted into the chuck (not shown) of a power drill (not shown) and the chuck tightened. The tip 60 of the rotary tool 10 is inserted into the centre of a plant, such as a weed, for example a dandelion, in earth such as, but not limited to: lawns, clay dirt, sandy dirt, tree wells, flower beds, loose gravel, junipers, small shrubs, compacted earth or virtually any area. The drill (not shown) is activated to rotate the shaft 20 and thereby the blade 50. At least a gentle downward pressure is applied by the operator which cooperates with the auger effect of the rotation of the blade 50 to cause the rotary tool 10 to pull its way into the earth. The operator can select how deep to penetrate the earth by applying more or less downward pressure, or by applying more or less upward pressure. For small weeds, 1″-2″ deep is sufficient, but for large weeds 2″-5″ is desired. Once the desired depth is achieved, the operator provides upward pressure sufficient to pull the rotary tool 10 out of the earth while the rotary drive continues to rotate the rotary tool 10. This allows the blade 50 to grind through the root of the weed to form a fine pulp which reduces the chance that the weed will regrow. This operation can be repeated as desired.

The inventor has found that the tapering outer edge makes the blade's operation more efficient, causing it to bind less in the resulting bore hole and assisting in the destruction of the root matter once the hole is bored.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A rotatable tool for removing weeds from earth, for use with a rotary drive, comprising:
(a) an elongate substantially straight shaft comprising a tip end and a drive end, said drive end being adapted to be driven by the rotary drive, said tip end being adapted to penetrate the earth, and
(b) a blade extending radially from the shaft, proximate the tip end, connected to rotate with the shaft.

2. The tool of claim 1, wherein the blade comprises substantially planar surfaces, fixed at a blade pitch approximately perpendicular to the longitudinal axis of the shaft.

3. The tool of claim 2, wherein the blade pitch is approximately 20 degrees.

4. The tool of claim 2, wherein the blade is substantially square.

5. The tool of claim 4, wherein the blade comprises an outer edge tapered inward from a leading edge to a trailing edge, at an edge angle.

6. The tool of claim 5, wherein the edge angle is approximately 20 degrees.

7. The tool of claim 2, wherein the blade is a knife.

8. The tool of claim 1, wherein the end of the tip end is generally tapered.

9. The tool of claim 1, wherein the tip end is substantially conical, having a cone angle.

10. The tool of claim 9, wherein the cone angle is about 7 degrees.

11. The tool of claim 10, wherein the tip end is radiused to a tip radius.

12. The tool of claim 11, wherein the tip radius is approximately 1/32′.

13. The tool of claim 1, wherein the drive end comprises connection means, adapted to be non-rotatably gripped by the rotary drive.

14. The tool of claim 7, wherein the connection means comprises a plurality of substantially flat surfaces at the drive end of the shaft, wherein the flat surfaces are adapted to be gripped by the chuck of the rotary drive.

15. The tool of claim 8, wherein the flat surfaces comprises 3 flats, each 120 degrees apart.

16. The tool of claim 1, wherein the shaft measures approximately 28.5″ between the tip end and the drive end.

17. The tool of claim 1, wherein there is approximately 2″ between the tip end and the blade.

18. The tool of claim 1, wherein the tip portion is approximately 3″ long.

19. The tool of claim 1, wherein the drive portion is approximately 1.5″ long.

20. The tool of claim 1, wherein the shaft is approximately ⅜″ in diameter.
